(19) United States
(12) Patent Application Publication
(10) Pub. No.: US 2019/0190342 A1
(43) Pub. Date: Jun. 20, 2019

(54) MOTOR FRAME WITH BUMPS

(71) Applicant: TECO Electric & Machinery Co., Ltd., Taipei City (TW)

(72) Inventors: Chi-Hsin WANG, Taipei City (TW); Cheng-Han TSAI, Taipei City (TW); Zih-Yang FANG, Taipei City (TW)

(21) Appl. No.: 15/876,506

(22) Filed: Jan. 22, 2018

(30) Foreign Application Priority Data
Dec. 20, 2017 (TW) 106144859

(51) Int. Cl. H02K 5/18; H02K 9/08

(52) U.S. Cl. CPC H02K 5/18; H02K 9/08

(57) ABSTRACT

A motor frame with bumps includes a frame body, plural bumps and plural heat-dissipation fins. The frame body has an internal surface and an external surface. Each of the bumps protrudes radially inward from the inner surface, and plural internal flow passages are formed by every two neighboring bumps. Each of the heat-dissipation fins protrudes radially outward from the external surface, and plural external flow passages are formed by every two neighboring heat-dissipation fins. Each of the bumps is radially outwards respective to at least two of the heat-dissipation fins.

### BACKGROUND OF THE INVENTION

### 1. Field of the Invention

The invention relates to a motor frame, and more particularly to the motor frame having bumps for heat conduction.

### 2. Description of the Prior Art

A motor is a device that can transform electric energy into mechanical kinetic energy by electromagnetic induction. While in transforming the electric energy into the corresponding kinetic energy, electric current would flow through stator coils, so that corresponding electromagnetic effect can be induced. However, while the electric current flows, excess thermal energy would be generated due to current loss (for example, copper loss or iron loss) from electric resistance of the stator coils. This thermal energy would somehow damage internal elements of the motor, and further affect the operation of motor.

In details, refer to FIG. 1 through FIG. 2; where FIG. 1 is a schematic front view of a conventional motor frame, and FIG. 2 is a schematic cross-sectional view of FIG. 1 along line A-A. As shown, the conventional motor frame PA1 includes a frame body PA11 and a plurality of heat-dissipation fins PA12 (only one labeled in the figure). Out of the frame body PA11, four fin-mounting portions PA111, PA111a, PA111b and PA111c are provided. As shown, among three fin-mounting portions PA111, PA111a and PA111b, two wiring passages PAT1 (only one labeled in the figure) are provided, each of the wiring passages PAT1 is to define walls of the frame body PA11 into an inner passage wall PA112 and an external passage wall PA113.

Referring now to FIG. 3, an operation state of the conventional motor frame associated with a major motor assembly is schematically shown. The major motor assembly PA2 includes a first fan PA21, a second fan PA22, a stator PA23, a rotor PA24, a front-end cover PA25, a back-end cover PA26, an external fan PA27 and a fancover PA28. The rotor PA24 is furnished with a rotor heat-dissipation passage PAT2. The first fan PA21 and the second fan PA22 are disposed, respectively, at two opposing ends of a center axis (not labeled in the figure) of the rotor PA24. The front-end cover PA25 and the back-end cover PA26 are to cover two opposing ends of the frame body PA11, such that a sealed room can be formed inside the frame body 11. The external fan PA27 is disposed at one end of the center axis of the rotor PA24 and out of the frame body PA11. The fancover PA28 is to cover the external fan PA27.

The motor PA100 includes the motor frame PA1 and the major motor assembly PA2. As the motor PA100 runs, excess thermal energy would be generated while in transforming the electric energy into kinetic energy. Hence, temperatures of individual internal elements of the motor would rise. With the rotation of the rotor PA24, the first fan PA21 and the second fan PA22 would induce internal air flow of the frame body PA11, so as further to form an internal heat-dissipation flow PAF1. The internal heat-dissipation flow PAF1 would carry away the thermal energy in the rotor heat-dissipation passage PAT2, and the thermal energy gone with the internal heat-dissipation flow PAF1 would be transferred into the wiring passage PAT1. Via heat conduction from the inner passage wall PA112 to the external passage wall PA113, the thermal energy in the wiring passage PAT1 would be shipped out of the wiring passage PAT1. Finally, via an external heat-dissipation flow PAF2 generated by the external fan PA27, the thermal energy would be further dissipated into the atmosphere.

However, the existence of the wiring passage PAT1, served also as a heat-dissipation channel of internal air circulation, would occupy space for constructing the heat-dissipation fins PA12. The reduction in the heat-dissipation fins PA12 would contribute the wiring passage PAT1 with larger thermal resistance. Further, the construction of the wiring passage PAT1 would detour the external heat-dissipation flow PAF2 generated by the external fan PA27. Thereby, after the external heat-dissipation flow PAF2 passes the heat-dissipation fins PA12, a windward side and a lee side would be there to make difference. Apparently, the windward side can provide better heat-dissipation efficiency than the lee side can do. Thus, hot spots would be easily formed at the wiring passage PAT1 respective to the lee side. Such an ill distribution of temperature on the motor frame PA1 would definitely hurt the entire performance of heat dissipation.

### SUMMARY OF THE INVENTION

In view of the prior art, since the existence of the wiring passages may sacrifice the amount of the heat-dissipation fins. In addition, as the external heat-dissipational flow passes the heat-dissipation fins, the windward side and the lee side with respect to the flow are generated, from which different heat-dissipation efficiency are formed. Thereupon, hot spots would be easily formed at the wiring passage respective to the lee side. Thereby, the major motor assembly would be kept in a high-temperature environment as long as the motor is running. It can be foreseen that, under such an operation situation, the motor would be eventually burned down or damaged at least. In addition, hot spots would cause a non-uniform temperature distribution inside the motor frame, and thus would be harmful to the entire heat dissipation of the motor.

Accordingly, it is an object of the present invention to provide a motor frame with bumps for sleeving a major motor assembly includes a frame body, a plurality of bumps and a plurality of heat-dissipation fins. The frame body has an internal surface and an external surface, extends in an extension direction parallel to a center axis, and is defined orderly in the extension direction to have a first fan-accommodating section, a major accommodating section and a second fan-accommodating section. The first fan-accommodating section is to accommodate a first fan, the major accommodating section is to accommodate the major motor assembly, and the second fan-accommodating section is to accommodate a second fan. The plurality of bumps protrude individually toward the center axis from the internal surface, extend from a conjunction of the first fan-accommodating section and the major accommodating section to another conjunction of the second fan-accommodating section and the major accommodating section, and contact the major motor assembly so as to conduct a thermal energy generated by running the major motor assembly. A plurality of internal heat-dissipation passages are individually formed between every two neighboring bumps. The plurality of heat-dissipation fins protrude individually from the external surface by back-warding the center axis, and extend in the extension direction. A plurality of external heat-dissipation passages are individually formed between every two neighboring heat-dissipation fins, and extend in the extension direction. Each of the plurality of bumps is radially outwards respective to at least two of the plurality of heat-dissipation fins, and each of the plurality of internal heat-dissipation passages is to flow a internal heat-dissipation flow.

In one embodiment of the present invention, the motor frame with bumps further includes a mounting structure on the frame body for supporting and positioning the frame body.

In one embodiment of the present invention, the major motor assembly is furnished with a rotor passage and a stator passage, and a heat-dissipation flow circulation space for circulating the internal heat-dissipation flow is formed by integrating the first fan-accommodating section, the internal flow passage, the second fan-accommodating section, the rotor passage and the stator passage.

In one embodiment of the present invention, the plurality of heat-dissipation fins have individual correspondence sections, and each of the plurality of bumps is radially outwards respective to at least two of the correspondence sections of the plurality of heat-dissipation fins.

In one embodiment of the present invention, the plurality of bumps extends in the extension direction from the conjunction of the first fan-accommodating section and the major accommodating section to the another conjunction of the second fan-accommodating section and the major accommodating section, and the internal heat-dissipation passage is formed by having every two neighboring said bumps to define therebetween one of the plurality of internal heat-dissipation passages extending in the extension direction.

In one embodiment of the present invention, the frame body has a frame-extension length in the extension direction, each of the plurality of bumps has a bump-extension length in the extension direction, and the bump-extension length is smaller than the frame-extension length.

As described above, by providing the motor frame of the present invention to include a plurality of bumps, every two neighboring bumps are used to form in between an internal flow passage extending in the extension direction, and thereby a heat-dissipation flow circulation space can be formed.

Thereupon, even more heat-dissipation efficiency can be achieved by the motor frame with bumps of the present invention.

In comparison with the prior art, the motor frame with bumps can implement the bumps respective radially outwards to a plurality of heat-dissipation fins for conducting the thermal energy generated by the major motor assembly, and provides more available contact surfaces for heat transfer. Thereupon, more thermal energy can be transferred per unit time. Also, the inclusion of the internal flow passages defined by every two neighboring bumps can allow the internal heat-dissipation flow to flow through, and thus the thermal energy absorbed and carried away by the internal heat-dissipation flow can be dissipated to the frame body. Finally, the heat-dissipation fins take charge in dissipating the thermal energy into the atmosphere. In addition, the number of the heat-dissipation fins at a place radially outwards respective to the internal heat-dissipation passage can be reduced, and thus the usage efficiency of the heat-dissipation fins and the space occupied by the frame body can be substantially increased. Thereupon, the goal of lightweight in the frame body can be achieved without trading off the heat-dissipation performance.

All these objects are achieved by the motor frame with bumps described below.

### BRIEF DESCRIPTION OF THE DRAWINGS

The present invention will now be specified with reference to its preferred embodiment illustrated in the drawings, in which:

FIG. 1 is a schematic front view of a conventional motor frame;

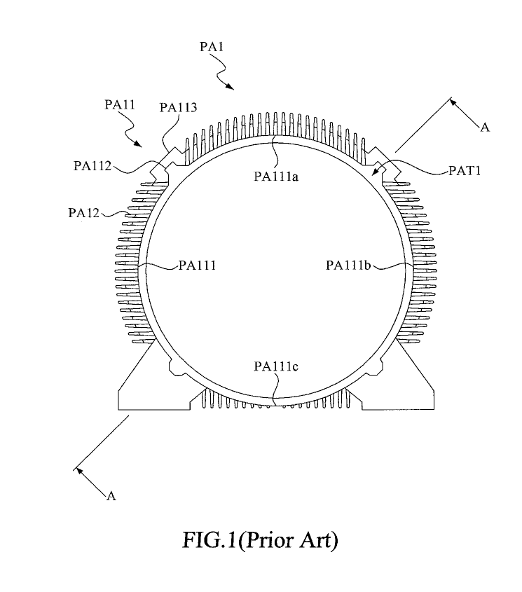

FIG. 2 is a schematic cross-sectional view of FIG. 1 along line A-A;

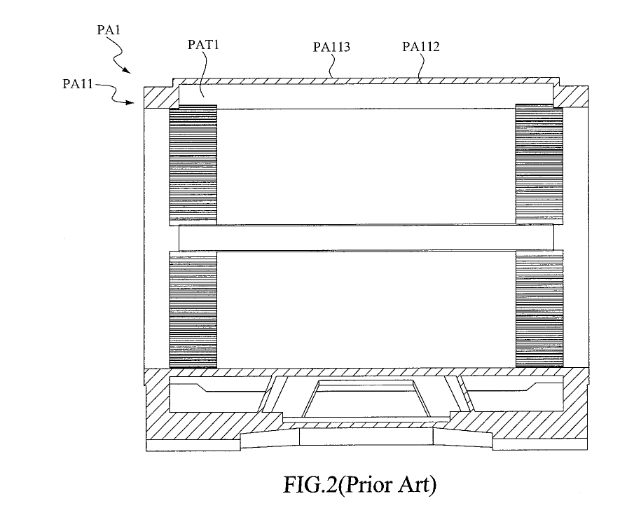

FIG. 3 demonstrates schematically an operation state of the conventional motor frame associated with a major motor assembly;

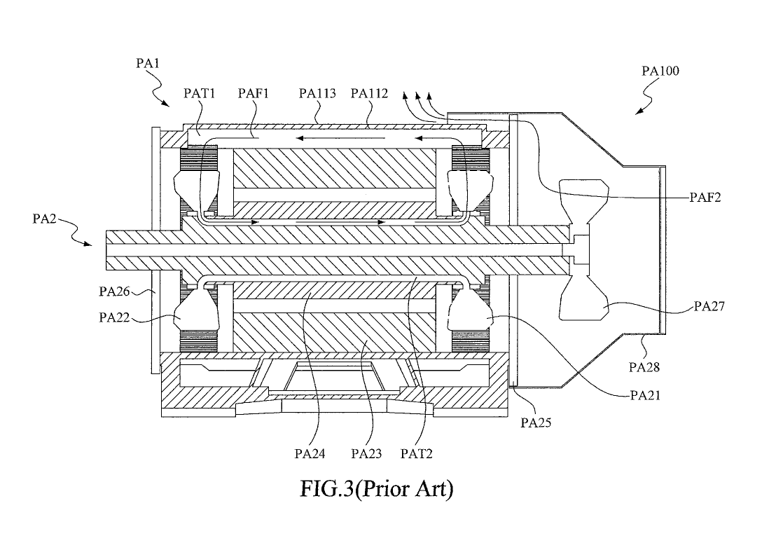

FIG. 4 is a schematic perspective view of a preferred embodiment of the motor frame with bumps in accordance with the present invention;

FIG. 5 is a schematic front view of FIG. 4;

FIG. 6 is a schematic cross-sectional view of FIG. 5 along line B-B;

FIG. 7 demonstrates schematically an operation state of the motor frame of FIG. 4 associated with the major motor assembly;

FIG. 8 is a schematic cross-sectional view of FIG. 5 along line C-C; and

FIG. 9 demonstrates schematically another operation state of the motor frame of FIG. 4 associated with the major motor assembly, particularly showing the heat dissipation flow.

### DESCRIPTION OF THE PREFERRED EMBODIMENT

The invention disclosed herein is directed to a motor frame with bumps. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

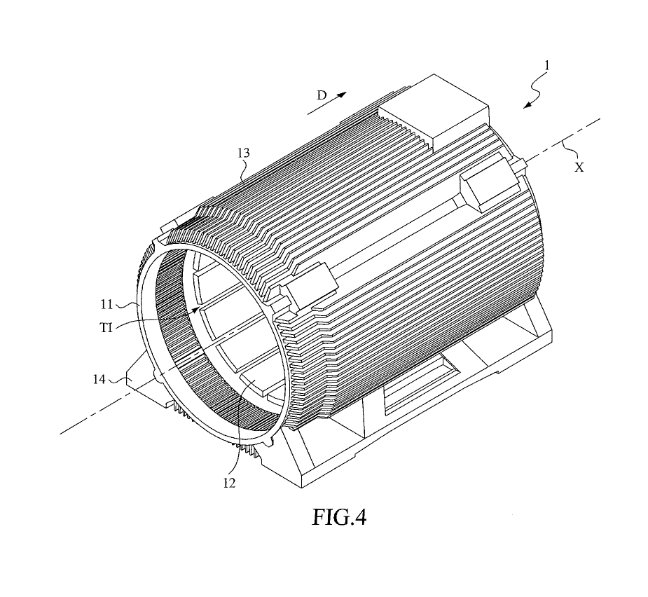

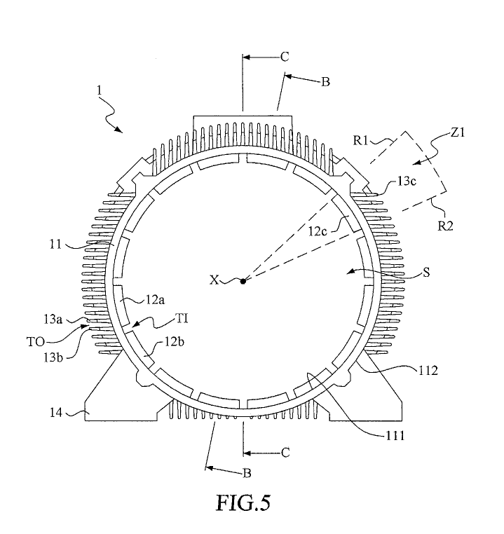

Refer now to FIG. 4 and FIG. 5; where FIG. 4 is a schematic perspective view of a preferred embodiment of the motor frame with bumps in accordance with the present invention, and FIG. 5 is a schematic front view of FIG. 4. As shown, the motor frame with bumps (“motor frame” thereafter) 1 includes a frame body 11, a plurality of bumps 12 (only one labeled in the figure) and a plurality of heat-dissipation fins 13 (only one labeled in the figure). In this preferred embodiment, the motor frame 1 further includes a mounting structure 14 for mounting and positioning the motor frame 1.

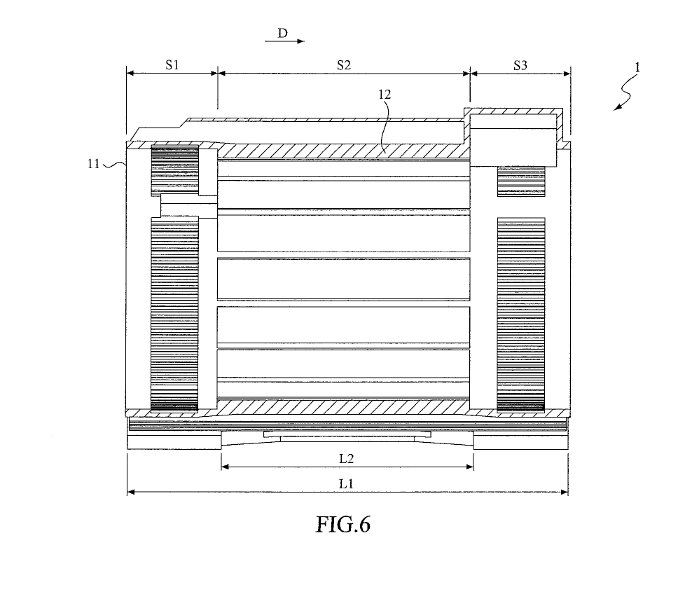

The frame body 11 has an internal surface 111 and an external surface 112, both of which extend in an extension direction D parallel to a center axis X. The frame body 11 are largely divided into a first fan-accommodating section S1 (see FIG. 6), a major accommodating section S2 (see FIG. 6) and a second fan-accommodating section S3 (see FIG. 6). The plurality of bumps 12 (only one labeled in the figure) protruding toward the center axis X directly from the internal surface 111 are spaced to each other, and each the bump 12 extends in the extension direction D from a conjunction of the first fan-accommodating section S1 and the major accommodating section S2 to another conjunction of the second fan-accommodating section S3 and the major accommodating section S2. A plurality of heat-dissipation fins 13 (only one labeled in the figure) protrude individually from the external surface 112 in a direction away from the center axis X. In addition, each of the bumps 12 is radially respective to at least two of the heat-dissipation fins 13.

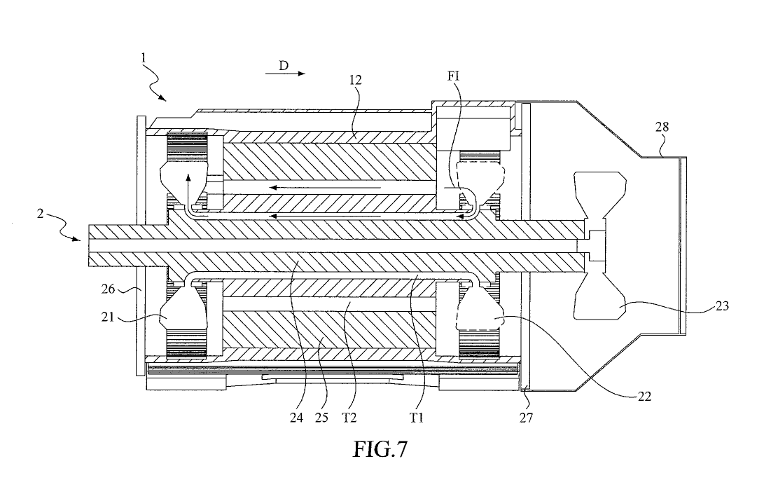

In details, the frame body 11 of the motor frame 1 is to form thereinside an accommodation space S for sleeving a major motor assembly 2 (see FIG. 7). As shown, every two neighboring bumps (12a and 12b for example) among the plurality of bumps 12 are there to define one of internal heat-dissipation passages TI (only one labeled in the figure) extending in the extension direction D and parallel to each other. Similarly, every two heat-dissipation fins 13 (13a and 13b for example) among the plurality of heat-dissipation fins 13 are there to define one of external heat-dissipation passages TO (only one labeled in the figure) extending in the extension direction D and parallel to each other.

As described above, each of the bumps 12 is radially outwards respective to at least two of the heat-dissipation fins 13 on the other side with respect to the wall of the frame body 11. It shall be elucidated further that, to understand the meaning of “one bump is radially outwards respective to at least two of the heat-dissipation fins”, FIG. 5 can be referred. As shown, two radial reference lines R1 and R2, both originated at the same center located on the center axis X, are extended outwards in corresponding radial directions and penetrate the respective internal heat-dissipation passages TI located neighborly to the concerned bump 12. In the present invention, the sector range limited by these two radial reference lines R1 and R2 is defined as a radial correspondence range Z1. Within the radial correspondence range Z1 of FIG. 5, a bump 12c and four heat-dissipation fins 13c (only one labeled in the figure) are included. Namely, one bump 12c is radially outwards respective to four heat-dissipation fins 13c. Following the same criterion, each of the bumps 12 is found to be respective to at least two of the plurality of heat-dissipation fins 13. In addition, due to different viewing angles, the radial correspondence range Z1 is actually a three-dimensional region elongated from a sector base.

Similarly, the internal heat-dissipation passage TI is also radially outwards respective to at least one of the plurality of heat-dissipation fins 13, and thus a corresponding radial correspondence passage range (not labeled in the figure) can be defined. Within the radial correspondence passage range, fewer heat-dissipation fins 13, than those within the radial correspondence range Z1, can be arranged do as to achieve the goal of lightweight for the motor.

In the preferred embodiment of the present invention, each bump 12 extends in the extension direction D, but not limited to, from the conjunction of the first fan-accommodating section S1 and the major accommodating section S2 to the conjunction of the second fan-accommodating section S3 and the major accommodating section S2. In other embodiments of the present invention, the bump 12 can extend in a first extension direction from the conjunction of the first fan-accommodating section S1 and the major accommodating section S2 to the conjunction of the second fan-accommodating section S3 and the major accommodating section S2, in which the first direction is neither parallel nor perpendicular to the extension direction D. Namely, the bump 12 extends in an oblique manner from the conjunction of the first fan-accommodating section S1 and the major accommodating section S2 to the conjunction of the second fan-accommodating section S3 and the major accommodating section S2.

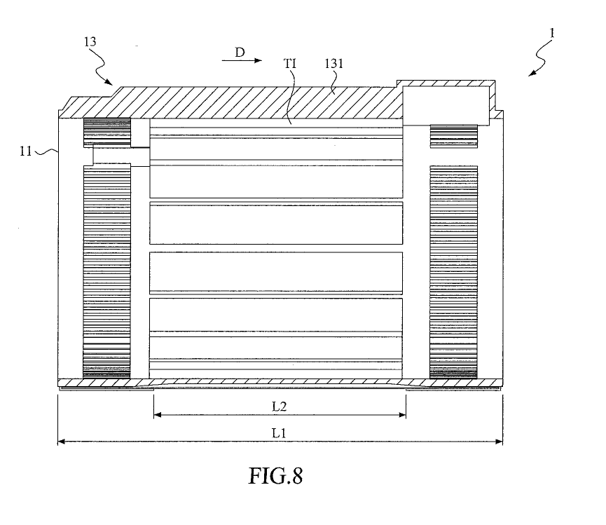

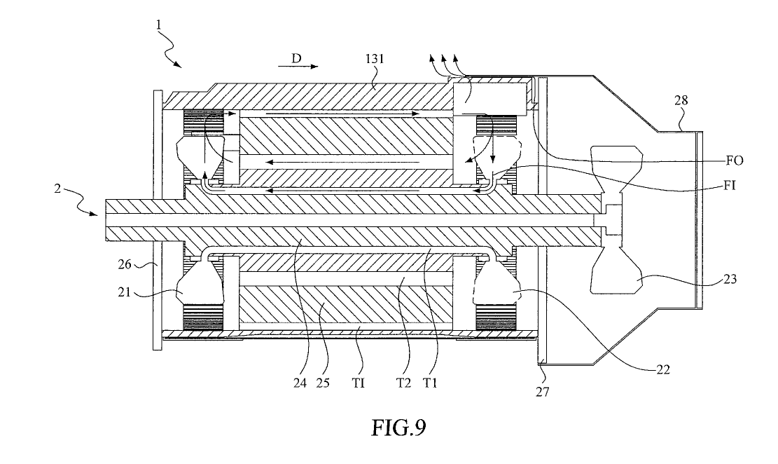

Refer also to FIG. 5 through FIG. 9; where FIG. 6 is a schematic cross-sectional view of FIG. 5 along line B-B, FIG. 7 demonstrates schematically an operation state of the motor frame of FIG. 4 associated with the major motor assembly, FIG. 8 is a schematic cross-sectional view of FIG. 5 along line C-C, and FIG. 9 demonstrates schematically another operation state of the motor frame of FIG. 4 associated with the major motor assembly, particularly showing the heat dissipation flow. As shown, the motor frame 1 is to sleeve the major motor assembly 2.

In the preferred embodiment of the present invention, the frame body 11 of the motor frame 1 has a frame-extension length L in the extension direction D, while the bump 12 has a bump-extension length L2 in the extension direction. The bump-extension length L2 is smaller than the frame-extension length L1. The area of the frame body 11 between the frame-extension length L1 and the bump-extension length L2 is the first fan-accommodating section S1 and the second fan-accommodating section S3. In addition, the internal heat-dissipation passage TI has a passage-extension length (not labeled in the figure) in the extension direction D equal to the bump-extension length L2.

In addition, in the preferred embodiment, the major motor assembly 2 sleeved by the motor frame 1 includes a first fan 21, a second fan 22, an external fan 23, a rotor structure 24, a stator structure 25, a front-end cover 26, a back-end cover 27 and a fancover 28. The first fan 21 and the second fan 22 is accommodated inside the first fan-accommodating section S1 and the second fan-accommodating section S3, respectively. The front-end cover 26 and the back-end cover 27 are to seal the accommodation space S (including S1˜S3) of the frame body 11 at both ends thereof, respectively, so that a unique sealed space can be formed. In the preferred embodiment, the major motor assembly 2 is furnished with a rotor passage T1 and a stator passage T2. While the major motor assembly 2 is running, a thermal energy would be generated inside the accommodation space S.

Inside the accommodation space S, the first fan-accommodating section S1, the internal flow passage TI, the second fan-accommodating section S3, the rotor passage T1 and the stator passage T2 would be integrated to form an air-circulation space for circulating an internal heat-dissipation flow FI, such that the thermal energy inside the accommodation space S can be dissipated through the internal heat-dissipation flow FI.

As shown in FIG. 7, the bumps 12 are structurally connected with the stator structure 25, so that part of the thermal energy of the stator structure 15 can be thermally transferred to the bumps 12 by heat conduction, and then further to the corresponding heat-dissipation fins 13. Since the bumps 12 are radially outwards respective to the plurality of heat-dissipation fins 13 as shown in FIG. 5, and thus the area available for heat contact and heat conduction would be substantially increased than the prior art can do. Namely, the plurality of heat-dissipation fins 13 of this present invention can dissipate the thermal energy more efficiently. In the preferred embodiment of the present invention, each of the heat-dissipation fins 13 further has a correspondence section 131. The correspondence section 131 has a correspondence section length (not labeled in the figure) equal to the bump-extension length L2 in the extension direction D, so as to have the bump 12 to match radially the correspondence sections 131 of the corresponding heat-dissipation fins 13.

In addition, as shown in FIG. 9, as the first fan 21 and the second fan 22 run, the aforesaid internal heat-dissipation flow FI would be generated so as to discharge the thermal energy in the rotor passage T1 and the stator passage T2 to the internal heat-dissipation flow FI. Then, the internal heat-dissipation flow FI would flow from the rotor passage T1 and the stator passage T2 to the first fan-accommodating section S1, driven continuously by the first fan 21 and the second fan 22, and further to the internal heat-dissipation passage TI. When the internal heat-dissipation flow FI is driven to reach the internal heat-dissipation passage TI, the thermal energy carried by the internal heat-dissipation flow FI (mainly at the rotor passage T1 and the stator passage T2) would be dissipated to the frame body at the internal heat-dissipation passage TI. Via the protrusive heat-dissipation fins 13 integrated as a unit to the frame body 11, the thermal energy would be dissipated into the atmosphere. Then, the first fan 21 and the second fan 22 keep driving the internal heat-dissipation flow FI to orderly flow through the second fan-accommodating section S3, the rotor passage T1 and the stator passage T2. After the internal heat-dissipation flow FI flows through the rotor passage T1 and the stator passage T2 again, the aforesaid heat-dissipation process is performed again. Namely, repeating heat-dissipation processes can be performed by continuously circulating the internal heat-dissipation flow FI in the air-circulation space.

In the preferred embodiment of the present invention, the first fan 21 and the second fan 22 are furnished together. However, in practice, the aforesaid internal air circulation can be also achieved by simply implementing one of the first fan 21 and the second fan 22.

Thereupon, the thermal energy in the accommodation space S can be transferred to the frame body 11 by the bumps 12 and also by the cooperation of the internal heat-dissipation passage TI and the internal heat-dissipation flow FI. After the thermal energy is transferred to the frame body 11, the heat-dissipation fins 13 on the frame body 11 would take the charge to dissipate the thermal energy into the atmosphere.

Preferably, in the preferred embodiment of the present invention, the external fan 23 would guide an external heat-dissipation flow FO to pass through the heat-dissipation fins 13 and the external heat-dissipation passage TO, so that an enforced heat convection can take place among the heat-dissipation fins 13, the external heat-dissipation passage TO and the atmosphere. Thereupon, better heat-dissipation efficiency can be achieved.

In some other embodiments of the present invention, each of the bumps 12 can extend obliquely from the conjunction of the first fan-accommodating section S1 and the major accommodating section S2 to that of the second fan-accommodating section S3 and the major accommodating section S2. In this circumstance, by viewing from the first fan 21 to the second fan 22, as the first fan 21 rotates counter clockwisely, and if the bumps 12 extend leftwards from the conjunction of the first fan-accommodating section S1 and the major accommodating section S2 to that of the second fan-accommodating section S3 and the major accommodating section S2, the internal heat-dissipation passages TI would be formed as leftward passages that match the rotation of the first fan 21, such that an internal pressure drop of the motor frame 1 can be smaller so as to obtain a larger internal heat-dissipation flow FI and thus to provide better heat-dissipation efficiency. Similarly, as the first fan 21 rotates clockwisely, and if the bumps 12 extend rightwards from the conjunction of the first fan-accommodating section S1 and the major accommodating section S2 to that of the second fan-accommodating section S3 and the major accommodating section S2, the internal heat-dissipation passage TI can also be provided to right match the rotation of the first fan 21.

In summary, by providing the motor frame of the present invention to include a plurality of bumps, and by having any two neighboring bumps to form an internal flow passage in between, then a plurality of internal flow passages can be structured, and each of the bumps can be radially outwards respective to at least two of plural heat-dissipation fins.

In comparison with the prior art, the preferred motor frame with bumps provided by the present invention can implement the bumps to better pair the plurality of heat-dissipation fins, such that more thermal energy can be transferred per unit time. Further, the inclusion of the internal flow passages defined by every two neighboring bumps can allow the internal heat-dissipation flow to flow through, and thus the thermal energy absorbed and carried away by the internal heat-dissipation flow can be dissipated to the frame body. Thereupon, even more heat-dissipation efficiency can be achieved by the motor frame with bumps of the present invention.

While the present invention has been particularly shown and described with reference to a preferred embodiment, it will be understood by those skilled in the art that various changes in forth and detail may be without departing from the spirit and scope of the present invention.

What is claimed is:

1. A motor frame with bumps, sleeving a major motor assembly, comprising:
a frame body, having an internal surface and an external surface, extending in an extension direction parallel to a center axis of the frame body, defined orderly in the extension direction to have a first fan-accommodating section, a major accommodating section and a second fan-accommodating section, the first fan-accommodating section being to accommodate a first fan, the major accommodating section being to accommodate the major motor assembly, the second fan-accommodating section being to accommodate a second fan;
a plurality of bumps, protruding individually toward the center axis from the internal surface, extending from a conjunction of the first fan-accommodating section and the major accommodating section to another conjunction of the second fan-accommodating section and the major accommodating section, contacting the major motor assembly so as to conduct a thermal energy generated by running the major motor assembly, a plurality of internal heat-dissipation passages being individually formed between every two neighboring said bumps; and
a plurality of heat-dissipation fins, protruding individually from the external surface by back-warding the center axis, extending in the extension direction, a plurality of external heat-dissipation passages being individually fixated between every two neighboring said heat-dissipation fins and extending in the extension direction;
wherein each of the plurality of bumps is radially outwards respective to at least two of the plurality of heat-dissipation fins, and each of the plurality of internal heat-dissipation passages is to flow a internal heat-dissipation flow.

2. The motor frame with bumps of claim 1, further including a mounting structure on the frame body for supporting and positioning the frame body.

3. The motor frame with bumps of claim 1, wherein the major motor assembly is furnished with a rotor passage and a stator passage, and a heat-dissipation flow circulation space for circulating the internal heat-dissipation flow is fainted by integrating the first fan-accommodating section, the internal flow passage, the second fan-accommodating section, the rotor passage and the stator passage.

4. The motor frame with bumps of claim 1, wherein the plurality of heat-dissipation fins have individual correspondence sections, and each of the plurality of bumps is radially outwards respective to at least two of the correspondence sections of the plurality of heat-dissipation fins.

5. The motor frame with bumps of claim 1, wherein the plurality of bumps extends in the extension direction from the conjunction of the first fan-accommodating section and the major accommodating section to the another conjunction of the second fan-accommodating section and the major accommodating section, and the internal heat-dissipation passage is formed by having every two neighboring said bumps to define therebetween one of the plurality of internal heat-dissipation passages extending in the extension direction.

6. The motor frame with bumps of claim 5, wherein the frame body has a frame-extension length in the extension direction, each of the plurality of bumps has a bump-extension length in the extension direction, and the bump-extension length is smaller than the frame-extension length.
